(19) United States
(12) Patent Application Publication
(10) Pub. No.: US 2011/0124785 A1
(43) Pub. Date: May 26, 2011

(54) ANTI-FOGGING AGENT BASED ON POLYGLYCEROL AND NATURAL OILS

(76) Inventors: Peter Daute, Beverstedt (DE); Martin Schafer, Stubben (DE)

(21) Appl. No.: 12/995,249

(22) PCT Filed: Jun. 2, 2009
(86) PCT No.: PCT/EP2009/056742

§ 371 Date: Jan. 27, 2011

(30) Foreign Application Priority Data
Jun. 2, 2008 (DE) 10 2008 026 263.3

(51) Int. Cl. C08K 11/00

(52) U.S. Cl. 524/315; 252/182.12

(57) ABSTRACT

The invention provides an anti-fogging agent comprising an ester product and at least one further anti-fogging agent. The invention also relates to shaped articles and polymer compositions comprising such anti-fogging agents, and the preparation and use thereof.

The invention generally provides ester products, and the use thereof as anti-fogging agents, anti-fogging agents and processes for the preparation thereof. The invention also relates to shaped articles and polymer compositions comprising such anti-fogging agents, and the preparation and use thereof.

During the processing of plastics, anti-fogging agents are often added to these. These then serve to prevent the condensation of water and the formation of drops of water on the surface of the plastics. Such additives are often employed in the production of transparent packaging's and films. Without anti-fogging agents, a deposit forms on the inside, especially on transparent packaging films, as a result of which the contents of the packaging are scarcely or no longer detectable, as can be seen from Plastics Additives Handbook, 5th edition, Hanser Verlag, p. 609-626. The prevention of deposits is also of importance in other uses, for example spectacles, windows or visors of helmets as three-dimensional forms. Generally, internal anti-fogging agents are incorporated into the plastic and therefore become part of the plastic and therefore also of the three-dimensional form containing this plastic, while external anti-fogging agents are applied externally to the plastic and therefore become part of the plastic as a surface layer and therefore also of the three-dimensional form comprising this.

DE 10 2004 038 980 A1 discloses anti-fogging agents for plastics which are obtainable by transesterification of natural oils with polyethylene glycol.

U.S. Pat. No. 3,759,856 provides stabilizers for plastics, such as PVC, based on partial glycerol esters of monocarboxylic acids. The esters impart to the plastics anti-fogging properties and antistatic properties. The esters are obtained by reaction of polyglycerol with fatty acids or with fatty acid mixtures, for which either no catalyst or an acid catalyst is employed.

U.S. Pat. No. 5,302,327 discloses a process for the production of thermoplastic layers with anti-fogging properties by means of corona discharge. Polyglycerol esters or sorbitan esters of fatty acids are employed as anti-fogging agents. Monoesters are preferably employed. By way of example, the product Glycolube AFA-1 from Lonza Inc. is employed.

Generally, one object lies in overcoming the disadvantages emerging from the prior art. Furthermore, the known agents often do not have optimum properties with respect to the prevention of the formation of drops. There is therefore a continuous need to improve the known anti-fogging agents and to simplify the preparation processes. Since large quantities of anti-fogging agents are employed worldwide, a more efficient preparation process and an easier availability of the raw materials would be of significance.

In particular, processes for the preparation of anti-fogging agents which can be carried out by a simple method and manner with few process steps are to be provided. Overall, the preparation of anti-fogging agents is to be facilitated and the availability of the raw materials improved. At the same time, the anti-fogging agents according to the invention should have good anti-fogging properties. The invention is based in particular on the object of achieving anti-fogging properties which are at least equivalent to those of known agents, or even of improving these. In this context, under moisture conditions the formation of drops on the plastics should take place as early as possible and a clear film should form from these as rapidly as possible. An improved packed product is thus also to be provided.

A contribution towards achieving at least one of the above objects is made by a process, an ester product, an anti-fogging agent, a polymer composition, a shaped article and the use thereof according to the particular classifying claims, the sub-claims in each case dependent thereon relating to preferred embodiments.

The invention provides an anti-fogging agent comprising
a) an ester product obtainable by a process comprising as process steps:
   S1) provision of a reaction mixture comprising as reaction components
      S1a) a polyglycerol comprising at least two glycerol units;
      S1b) an oil based on a natural oil;
   S2) reaction of the reaction mixture by a transesterification in the presence of a basic catalyst to give the ester product;
b) at least one further anti-fogging agent chosen from the group consisting of a polyethylene glycol ether, a partial glyceride or a polyethylene glycol ester or a mixture of at least two of these.

In view of the basic catalyzed transesterification, the process differs from known processes for the preparation of anti-fogging agents, in which the anti-fogging agents are obtained by an esterification of fatty acids.

According to the invention, both individual pure esters and ester mixtures with two and more individual esters which differ from one another are understood as the ester product. Preferably, the ester product comprises a particular polyglycerol partial ester to the extent of at least 20 wt. %, preferably to the extent of at least 30 wt. % and particularly preferably to the extent of at least 60 wt. %, in each case based on the ester product. In some cases, the particular one polyglycerol partial ester is found up to a maximum of 80 or 90 wt. %, in each case based on the ester product.

Basic is preferably understood as meaning that the reaction mixture employed for the transesterification has a pH in a range of from 7 to 14, preferably from 8 to 14 and particularly preferably 9 to 13.

Furthermore, in one embodiment of the process according to the invention, the reaction mixture comprises the reaction components S1a and S1b to the extent of at least 50 wt. %, preferably to the extent of at least 75 wt. % and particularly preferably to the extent of at least 90 wt. %, in each case based on the total weight of the reaction mixture. In a particularly preferred embodiment, the reaction mixture comprises 10 to 95 wt. % of the oil, particularly preferably between 20 to 90 wt. % of the oil. In a further preferred embodiment, the reaction mixture comprises 5 to 90 wt. % of polyglycerol, particularly preferably 10 to 50 wt. % of polyglycerol or between 15 and 40 wt. % of polyglycerol. Preferably, the content of basic catalyst is less than 1 wt. %, particularly preferably less than 0.1 wt. %. Particularly preferably, the content of the basic catalyst in the reaction mixture is between 0.1 and 10 ppm. In a further preferred embodiment, the content of the further alcohol with at least two hydroxyl groups is between 0 and 20 wt. %, particularly preferably between 0.1 and 10 wt. %. Furthermore, in a further embodiment of the present invention the reaction mixture likewise comprises polyglycols, in particular polyethylene glycol or polypropylene glycol.

A process which is preferred according to the invention is that wherein the process is carried out in a reaction mixture which contains the following reaction components:
at least 5, preferably at least 10 and particularly preferably at least 15 wt. % of oil;
from 5 to 95, preferably from 10 to 90 and particularly preferably from 5 to 85 wt. % of polyglycerol;
from 0.0001 to 1, preferably from 0.001 to 0.5 and particularly preferably from 0.001 to 0.1 wt. % of basic catalyst;
from 0 to 40 wt. %, preferably from 0 to 30 and particularly preferably from 0 to 20 wt. % of a further alcohol with at least two hydroxyl groups;
from 0 to 20, preferably from 0 to 10 and particularly preferably from 0 to 5 wt. % of additives such as impurities, which differ from the above reaction components,
   wherein the sum of all the percentages by weight of the reaction components is 100.

Fatty acids are conventionally obtained chemically by isolation from fats or oils and by chemical synthesis. The process according to the invention has the advantage that the transesterification can be carried out directly starting from oils and polyglycerols. The process is thereby simplified and the availability of the raw materials is improved. Surprisingly, such ester products also show very good anti-fogging properties.

A process which is preferred according to the invention is that in which the esterification is carried out in a one-pot process. In a one-pot process, the oil, the polyglycerol and the basic catalyst are mixed and then reacted, preferably in the same reactor. In contrast to a two- or multi-stage process in which the oil is first cleaved into fatty acid and glycerol and esterification is then carried out, according to the invention the oil or the oils are present with a content of free fatty acids of less than 30 wt. %, preferably less than 15 wt. % and particularly preferably less than 5 wt. %, in each case based on the oil, before the start of the transesterification.

The basic catalysts which can be employed according to the invention preferably have a pH, determined in water at 25° C., of more than 7, preferably more than 8, particularly preferably more than 10 and moreover preferably more than 12. All the catalysts which are known to the person skilled in the art and seem suitable for the transesterification according to the invention are possible in principle. In a preferred embodiment of the invention, the basic catalyst is chosen from the group consisting of alkali metal hydroxide, alkaline earth metal hydroxide or hydroxides of main group III of the periodic table of the elements, in each case including their hydrates, or a mixture of at least two of these. Particularly preferred catalysts are sodium hydroxide, potassium hydroxide, lithium hydroxide or a mixture of at least two of these as alkali metal hydroxides, and magnesium hydroxide, calcium hydroxide or a mixture of two of these as an alkaline earth metal hydroxide, aluminum hydroxide or boron hydroxide or both as hydroxides of main group III and mixtures of at least two of these. Lithium hydroxide is particularly preferred, in particular the monohydrate of lithium hydroxide.

It is furthermore preferable according to the invention for the transesterification to be carried out under at least two pressures which differ from one another. It is preferable here for a first pressure prevailing during the transesterification to be greater than, preferably at least 10 mbar, particularly preferably at least 100 mbar, moreover preferably at least 200 mbar and furthermore preferably at least 250 mbar greater than an at least one further pressure which likewise prevails during the transesterification. In the process according to the invention, it is furthermore preferable for the at least one further pressure to be in a range of from 100 to 500 mbar, preferably from 150 to 450 mbar and particularly preferably from 250 to 350 mbar. It is furthermore preferable according to the invention for the first pressure and the at least one further pressure to follow one another with a time difference of at least 5 min, preferably at least 15 min and particularly preferably in a range of from 30 to 90 min.

It is furthermore preferable according to the invention for the reaction to be carried out at a temperature at which a transesterification takes place, which is often above 40° C. Generally, it is to be noted that the transesterification temperature is chosen such that the ester product is not discolored by too high an exposure to heat. It is preferable here to carry out the transesterification in a range of from 100 to 350° C., preferably from 150 to 300° C. and particularly preferably from 200 to 270° C. It is furthermore preferable for the transition from the first to the at least one further pressure to take place at least at a temperature above 40° C., and preferably at the abovementioned temperatures according to the invention. Thus, according to the invention it is furthermore preferable to carry out the transesterification over a reaction period of from 10 min to 10 h, preferably from 0.5 to 7 h and particularly preferably from 1 to 6 h. In the present case, the start of the reaction period is regarded as being when the transesterification starts to a noticeable extent, such as is the case, for example, at a temperature above 40° C.

According to the invention, the oil used is a natural oil, which can also be chemically modified. The term “oil” describes mixtures of esters of glycerol. Natural oils essentially consist of glycerol esters of aliphatic monocarboxylic acids, the so-called fatty acids. These have chain lengths of from 6 to 22 C atoms. The esters are also called triglycerides. “Oils” in the context of the invention are present if these are liquid above 40° C. Natural oils from different biological sources vary with respect to the nature and the distribution of the amounts of the fatty acids they contain. Natural oils according to the invention can be of either plant or animal origin. The natural oils according to the invention also include synthetically prepared oils which have a chemical structure the same as that of the natural oils. The use of natural oils with a content of triglycerides of greater than 50, preferably greater than 75 and particularly preferably greater than 90 wt. %, in each case based on the oil, is preferred according to the invention.

In a preferred embodiment of the invention, the content of C18 fatty acids in the total fatty acids which are esterified with the one glycerol of the oil is in a range of from 30 to 95, preferably 50 to 95 and particularly preferably from 75 to 95 and moreover preferably from 80 to 95 wt. %, in each case based on the oil. In a further embodiment, the content of unsaturated fatty acids in the glycerides is greater than 10, preferably greater than 30, in particular greater than 60 and particularly preferably greater than 70 wt. %, in each case based on the oil.

In a preferred embodiment of the invention, the oil is chosen from the group consisting of rape oil, castor oil, hydrogenated castor oil, sunflower oil, palm oil, tallow oil, hydrogenated tallow oil, coconut oil, groundnut oil and soya oil or a mixture of at least two of these, rape oil being particularly preferred. Sunflower oil is prepared from the seeds of the sunflower and comprises approximately 35 to 95% of C18 fatty acids. The content of unsaturated fatty acids is approximately between 20 and 75%. Castor oil is obtained from the seeds of the castor oil bush by cold pressing and comprises the glyceride of ricinoleic acid to the extent of about 80 to 85%. Rape oil is also called rapeseed oil and is obtained from the seeds of rape by pressing. The oil comprises about 63% of oleic acid and 20% of linoleic acid. Soya oil is obtained from soya beans by pressing, optionally followed by extraction of hydrocarbons, and comprises chiefly C18 fatty acids, which are predominantly unsaturated. Palm oil is obtained from the fruit pulp of palm fruits and comprises a high content of linoleic acid.

In the context of the invention, “chemically modified” means that the oil obtained from biological sources is subjected to a treatment which essentially does not influence the ester bonds and changes the chemical consistency of the oil. A chemical after-treatment process on natural oils which is preferred according to the invention is hardening, in which the carbon-carbon double and triple bonds contained in some fatty acid chains are converted into single bonds. The oils according to the invention can also be mixed with additives. Mixtures which comprise more than 50%, preferably more than 75% or 90% of natural oil are also regarded as natural oil in the context of the invention.

In the context of the invention, “polyglycerol” represents ethers from two or more glycerol molecules. In the context of the invention, the term polyglycerol therefore also includes diglycerol. The term polyglycerol also describes ether mixtures which have a particular distribution of dimers, trimers, tetramers etc. from glycerol, depending on their preparation process and subsequent separation steps. Numerous processes for the preparation of polyglycerols are known in the prior art, for example in U.S. Pat. No. 3,968,169. Solvay Chemicals International offers a diglycerol and a polyglycerol under the brand names “Solvay Diglycerol” and “Solvay Polyglycerol-3”. Polyglycerols serve industrially as starting substances for the preparation of cosmetics, as emulsifiers for industrial use and as additives for foodstuffs.

In a preferred embodiment of the invention, the polyglycerol has an average number of from 1.5 to 5 glycerol units per molecule. An average number of from 2 to 4 glycerol units per molecule is particularly preferred. Generally, it is particularly preferable for the polyglycerol to comprise more than 70 wt. %, preferably more than 80 wt. % and particularly preferably more than 85 wt. %, in each case based on the polyglycerol, of di-, tri- and tetraglycerol. In a particularly preferred embodiment of the invention, a mixture which comprises more than 30, particularly preferably more than 40% of triglycerol is used as the polyglycerol. The use of a mixture which comprises less than 10% of monoglycerol, 20 to 40% of diglycerol, 25 to 50% of triglycerol and 10 to 30% of tetraglycerol and less than 20% of polyglycerols of 5 glycerol sub-units or more is particularly preferred. This corresponds to the distribution of glycerols in the product “Solvay Polyglycerol-3”, the use of which is particularly preferred.

A process in which the transesterification is carried out in the presence of at least one further alcohol which differs from the polyglycerol is preferred according to the invention. In a preferred embodiment of the invention, the further alcohol comprises at least two, preferably 2 to 50, particularly preferably 2 to 40 and furthermore preferably 2 to 20 hydroxyl groups. In a preferred embodiment of the invention, the further alcohol is chosen from the group consisting of glycerol, sorbitol, pentaerythritol and trimethylolpropane or alkoxylates thereof, polyethylene glycol, preferably with 2 to 200 ethylene oxide recurring units, polypropylene glycol, preferably with 2 to 200 ethylene oxide recurring units, or mixtures of at least two of these, glycerol, sorbitol or polyethylene glycol being preferred.

The invention also provides an ester product which is obtainable by a process according to the invention.

An ester product with at least one, preferably each of the following properties is preferred according to the invention:
P1 a viscosity in a range of from 1.5 to 6,000, preferably from 5 to 4,000 and particularly preferably from 10 to 3,000 mPas,
P2 a density of between 0.8 and 1.4, preferably from 0.85 to 1.35 and particularly preferably from 0.85 to 1.3 g/cm³.

The invention also provides an anti-fogging agent which comprises an ester product according to the invention, preferably in an amount in a range of from 10 to 99.9 and preferably from 15 to 95 wt. %, in each case based on the anti-fogging agent. An anti-fogging agent for use as an internal anti-fogging agent is particularly preferred.

An anti-fogging agent composition comprising at least one further anti-fogging agent is preferred according to the invention. This means that it comprises a further substance which improves the anti-fogging action of the agent and which is not an ester product according to the invention from the transesterification of a natural oil with a polyglycerol. In a preferred embodiment of the invention, the further anti-fogging agent is a polyethylene glycol ether, a partial glyceride or a polyethylene glycol ester or a mixture of at least two of these. A polyethylene glycol oleate, in particular polyethylene glycol sorbitan monooleate, is particularly preferred. The further anti-fogging agent or a mixture of further anti-fogging agents is preferably employed in a ratio of from 1:10 to 10:1 to the ester product according to the invention. Particularly preferably, the ratio is between 1:2 and 2:1.

The invention also provides a polymer composition comprising an ester product or anti-fogging agent according to the invention or both and at least one polymer. In principle, any polymer which can be melted is possible. This includes, in particular, linear polymers and branched polymers, which are in each case called, generally, thermoplastics. The polymers which the polymer composition comprises according to the invention can be obtained by any processes known to the person skilled in the art for the preparation of thermoplastics, such as polycondensation, poly-ring opening, polyaddition, metal-catalyzed, anionic, cationic and free radical polymerization. In a preferred embodiment of the invention, the polymer is chosen from the group consisting of polyvinyl chloride, polypropylene, polyethylene, polyethylene/polypropylene copolymers, polyethylene terephthalate, polylactate, polycarbonate, copolymers or polyester and mixtures of at least two of these. Copolymers which can be used are also those which comprise as a monomer unit one of the sub-units described above and have been copolymerized with a monomer unit which is not mentioned here.

In a preferred embodiment of the invention, the polymer composition comprises 0.01 to 10 wt. %, preferably 0.05 to 7 wt. % and particularly preferably 0.1 to 5 wt. %, in each case based on the polymer composition, of the ester product.

In a preferred embodiment of the invention, the polymer composition comprises 10 to 99.95, preferably 50 to 99 and particularly preferably 60 to 95 wt. %, in each case based on the polymer composition, of the polymer or polymers.

In further embodiments of the invention, the polymer composition or the anti-fogging agent comprises further additives chosen from the group consisting of stabilizers, lubricants, plasticizers, antiblocking agents, further anti-fogging agents, antistatics, flameproofing agents, dyestuffs, pigments, blowing agents, fillers, fats, oils and solvents or a mixture of at least two of these.

Stabilizers keep plastics, such as PVC, from decomposing or changing chemically at high temperatures, and improve resistance to weathering. For example, compounds based on lead, calcium, zinc, barium and tin are employed.

Lubricants serve to facilitate processing of PVC by reducing the friction between the PVC chains and reducing the adhesion of the PVC melt to the wall. Lubricants which are frequently used are metal soaps, such as lead and calcium stearates and laurates, which simultaneously act as a co-stabilizer.

Plasticizers impart suppleness and flexibility to the plastic. Many plasticizers belong to the group of phthalates (DEHP, DINP and DIDP), and of adipates and citrates.

Antiblocking agents are additives which prevent or reduce the sticking (“blocking”) of coated surfaces to one another or to substrates (e.g. during stacking or packing) Depending on the drying time in air, degree of drying, layer thickness, pressure or temperature under a certain loading, suitable release agents must be chosen, these as a rule being added to the coating substance and arriving at the surface during the drying phase. Paraffin, polyethylene wax, wax esters, silicone oils, stearates, modified silicas and talc, for example, are used for this.

Fillers, for example mineral fillers, such as chalk and talc, increase the strength and improve the insulating action.

Colored pigments, such as titanium oxide, which is also suitable for contact with foodstuffs, cosmetics and medicaments, serve as dyestuffs and pigments.

Water or organic solvents, such as alcohols, can be employed as solvents.

A polymer composition which comprises the following composition components is preferred according to the invention:
at least 10, preferably at least 15 and particularly preferably at least 20 wt. % of a polymer;
from 0.05 to 20, preferably 0.1 to 10 and particularly preferably 1 to 8 wt. % of the ester product;
from 0 to 10, preferably 0.1 to 10 and particularly preferably 1 to 8 wt. % of further anti-fogging agents;
from 0 to 75, preferably 5 to 70 and particularly preferably 10 to 65 wt. % of
additives which differ from the above composition components;
   wherein, in each case based on the polymer composition, the sum of all the percentages by weight is 100.

In a preferred embodiment of the invention, the polymer composition is a thermoplastic polymer composition. Thermoplastic polymer compositions are reversibly deformable from a certain temperature range. In further embodiments of the invention, the polymer composition is a non-crosslinked, crosslinkable polymer composition, for example for the preparation of elastomers.

The invention also provides the use of an ester product according to the invention as an anti-fogging agent, preferably as an internal anti-fogging agent. Internal anti-fogging agents are incorporated into polymer compositions before these are processed to shaped articles.

The invention also provides a process for the production of a shaped article, wherein a polymer composition according to the invention is processed to the shaped article. A “shaped article” in the context of the invention is a polymer composition which has been processed to a three-dimensional form. In this context, this can be a shaped article obtainable by thermal forming. Such shaped articles are obtained, for example, by processing thermoplastics by known processes. However, the shaped article can also be a crosslinked or vulcanized shaped article. Such shaped articles are obtained, for example, during processing of elastomers. The shaped article according to the invention has anti-fogging properties which are achieved due to the distribution of the anti-fogging agent in the shaped article and therefore also on the surface thereof.

The present invention also provides a shaped article comprising a polymer composition according to the invention or produced from a polymer composition according to the invention.

In a preferred embodiment of the invention, the shaped article is constructed in the form of a film, an outer facing, a transparent molding, a window, a visor or spectacle lens. Particularly preferably, the shaped articles serve as packaging materials, in particular in the form of films, outer facings and transparent moldings. Such packaging materials with anti-fogging properties are used for packaging of foodstuffs or other products with a moisture content. In such packaging materials, the anti-fogging properties alleviate or prevent fogging of the packaging materials from the inside. In further embodiments of the inventions, such as outer facings, windows, visors or spectacle lenses, the formation of drops and of accumulations of moisture on the outside and/or inside is prevented. The shaped articles according to the invention are particularly preferably transparent or at least transmit a proportion of light.

The thermoplastic polymer compositions according to the invention can be reacted generally by known processes to give the shaped articles according to the invention. In this context, the polymer formulations can first be worked up by known methods, for example by incorporation of additives or by conversion of the polymer composition into a suitable form, such as granules, powders, pastes or solutions. In this context, the polymer compositions are optionally mechanically treated, that is to say dispersed, kneaded or granulated. The processing to shaped articles is carried out, for example, by injection molding or extrusion. The moldings are optionally reworked, that is to say formed, cut, treated on the surface or welded. Curable polymer compositions are cured after pressing or forming to give moldings.

The invention also provides a process for use for the production of a shaped article, comprising the process steps:
I) provision of the thermoplastic composition comprising an ester product according to the invention or an anti-fogging agent according to the invention or both;
II) heating of the thermoplastic composition to the glass transition temperature of the thermoplastic polymer or to a temperature above the glass transition temperature of the thermoplastic polymer;
III) production of a shaped article from the heated thermoplastic composition prepared in process step II).

In step I) of the process according to the invention for the production of a shaped article, a thermoplastic composition according to the invention is first provided, this provision preferably being carried out by a process according to the first variant of the process according to the invention.

In process step II), the thermoplastic composition is then heated to the glass transition temperature of the thermoplastic polymer or to a temperature above the glass transition temperature of the thermoplastic polymer. In this connection, it is in turn preferable for the heating of the thermoplastic composition to be carried out to a temperature in a range of from 5 degrees below the glass transition temperature (T_{g}) to 100° C. above the glass transition temperature of the thermoplastic polymer employed, particularly preferably to a temperature in a range of from 1 degree below the glass transition temperature (T_{g}) to 50° C. above the glass transition temperature of the thermoplastic polymer employed and most preferably to a temperature in a range of from 1 degree above the glass transition temperature (T_{g}) to 20° C. above the glass transition temperature of the thermoplastic polymer employed, here also, however, the upper limit of the temperature range being essentially limited by the decomposition temperature of the thermoplastic polymer employed.

In principle, process steps I) and II) can be carried out simultaneously or in succession. It is appropriate to carry out process steps I) and II) simultaneously, for example, if the thermoplastic composition is prepared by means of a melt mixing process. Where appropriate, it may be advantageous here to convert the composition prepared by the melt mixing process directly into a shaped article. It is appropriate to carry out process steps I) and II) successively, for example, if the thermoplastic composition is prepared by means of a dry mixing process or if the thermoplastic composition is indeed prepared by means of a melt mixing process, but is not subjected to the formation of a shaped article directly after the preparation, but rather is first cooled according to process step v).

In process step III) of the process according to the invention for the production of a shaped article, a shaped article is produced from the heated thermoplastic composition prepared in process step II). Possible processes for the production of a shaped article are, in particular, injection molding, extrusion molding, compression molding, layer molding, laminating molding, blow molding, vacuum molding and transfer molding, injection molding being particularly preferred.

In a preferred embodiment of the invention, in a further process step IV) at least a part region of the shaped article obtained in process step III) is reduced in its mass cross-section compared with process step III).

The invention also provides a process for the production of a packed product, comprising as process steps the provision of a product and a shaped article according to the invention and at least partial surrounding of the product with the shaped article.

Furthermore, in an embodiment of the process according to the invention for the production of a thermoplastic shaped article, in at least one further process step IV) at least a part region of the shaped article obtained in process III) serves as a shaped article blank and is reduced in its mass cross-section by comparison. The mass cross-section is the cross-section of a region of the shaped article made solidly from the thermoplastic molding composition according to the invention. For example, in containers or vessels, the mass cross-section is the thickness of a wall of these containers or vessels. In the case of shaped articles which are rather thread- or strand-like in construction, the mass cross-section is the thickness of these threads or strands. In the case of rather planar structures, such as sheets, layers, webs, films or foils, the mass cross-section is the thickness of these planar structures. For the reduction in the mass cross-section, in principle all the methods known to the person skilled in the art and suitable for this are possible. These include, for example, stretching in one or two directions, drawing in one or two directions, centrifugation or blowing, each of which are preferably carried out at elevated temperatures at which the thermoplastic composition according to the invention is so soft or even liquid that stretching, drawing, centrifugation or blowing can be carried out. The part region in which the reduction in cross-section is effected preferably makes up at least 50% and particularly preferably at least 80% of the shaped article obtained in step III). Stretching or drawing are generally carried out if a fiber is to be obtained from the shaped article obtained in step III). For the production of films, on the one hand drawing or stretching in one or more dimensions can be carried out. Thus, the web running out of an extruder can be drawn on to a roll at a higher speed compared with the exit speed from the extruder. On the other hand, if a container or vessel is to be obtained, apart from stretching, drawing and centrifugation, blowing is chiefly carried out in step IV). In this, the reduction in mass cross-section is effected by applying a gas pressure. The gas pressure is generally chosen such that the thermoplastic composition, which is usually heated at least to the glass transition temperature, of the shaped article obtained in step III) can be extended. The extending is as a rule limited by using a mould having the final shape of the shaped article. It is furthermore possible for two or more of process steps I) to IV) to be supplemented by further process steps and/or to at least overlap in time. This applies in particular to process steps III) and IV).

A contribution towards achieving at least one of the abovementioned objects is furthermore made by a process for the production of a packed product, comprising as process steps:
a) provision of a product and a shaped article, in particular a film, the shaped article being obtainable by the process described above;
b) at least partial surrounding of the product with the shaped article.

The product provided in process step a) is preferably a pharmaceutical, a body care composition or a foodstuff. The at least partial surrounding of the product can be carried out, for example, by the process described in DE-A-103 56 769.

The objects on which the invention is based are achieved by the ester product according to the invention, the process for its preparation and the use as an anti-fogging agent. The transesterification process renders possible the preparation of an effective and active anti-fogging agent directly from natural oils. Natural oils are available in large quantities and inexpensively as a raw material. It is therefore not necessary to use the comparatively expensive pure fatty acids and mixtures thereof. In a process on a large industrial scale, such as the preparation of anti-fogging agents, this simplification means a significant saving in costs. Furthermore, it has been found, surprisingly, that in the preparation of anti-fogging agents directly starting from natural oils, very good anti-fogging properties are achieved. The plastics treated according to the invention show comparatively low clouding. In tests, the accumulation of drops on the film takes place only at a high humidity after relatively long times. The clearing of the films after the formation of drops takes place comparatively rapidly. The preparation process according to the invention and the properties of plastics treated according to the invention are explained in the following embodiment examples.

### Test Methods:

If not stated in detail in the following, the parameters described in this text are determined in accordance with the particular best suitable DIN specifications. Should no suitable DIN specification be available, the ISO specification which is most suitable is resorted to. Unless stated otherwise, all the properties are determined at 25° C.

The density is determined with a pyknometer, or 51550.

1. Color number

The color number is determined in accordance with ISO 15305 by the Lovibond method (Lov.)

2. Acid number

The acid number is determined in accordance with DIN EN ISO 3682.

3. Saponification number

The saponification number is determined in accordance with DIN EN ISO 3681.

4. Hot fogging test

The hot fogging test simulates the anti-fogging properties of films which are used for packagings which are filled with hot or warm foodstuffs which are then stored in the closed state. For this, a 250 ml glass beaker is filled with 200 ml of distilled water, and the glass is covered with a sample of the film to be tested and positioned in a bath temperature-controlled at 60° C. The intervals of time in which a change in the film becomes visible are then recorded over a period of 600 s.

5. Cold fogging test

This test simulates the anti-fogging properties of films which are used as packaging material for foodstuffs which are stored in the refrigerator. For this, a 250 ml glass beaker is filled with 200 ml of distilled water, and the glass is covered with a sample of the film to be tested and placed in a temperature-regulatable chamber temperature-controlled at 8° C. The intervals of time in which a change in the film becomes visible are then recorded over a period of 600 s.

### 6. Density

The density is determined in accordance with DIN 51757 V 4.

### 7. Viscosity

The viscosity is determined in accordance with DIN 1342 P1, 2.

8. Surface tension

The surface tension is determined in accordance with DIN 53914.

### EMBODIMENT EXAMPLES

### Example 1

### Transesterification of Rape Oil with Polyglycerol-3

255.6 g of rape oil, 74.4 g of Polyglycerol-3 (Solvay Chemicals) and 0.03 g of LiOH*H₂O were initially introduced into a glass flask and heated to 235° C., while stirring. After 1 h, a vacuum of 300 mbar was applied, and after a reaction time of 2 h the mixture was cooled. The product is a bright yellow liquid with the following properties:

Color 1″ Lov. yellow=1.6, Lov. red=0.5, acid number=0.10 mg of KOH/g, saponification number=146 mg of KOH/g, index(20° C.)=1.4772.

### Examples 2 and 3

### Production of the Test Specimens

Example:

| | E2 | E3 |
|---|---|---|
| PVC EVIPOL SH 7020 | 100 | 100 |
| DOA PLASTOMOL | 37 | 37 |
| EDENOL D 81 | 13 | 13 |
| STABIOL VCZ 2222 | 0.8 | 0.8 |
| LOXIOL G 10 V | 1.6 | — |
| DISPONIL SMO 120 SPEZ. | 0.8 | — |
| LOXIOL P 1508 | 0.1 | 0.1 |
| LOXIOL G 20 | 0.1 | 0.1 |
| Product of Example 1 | — | 2.4 |

The components were mixed together and the mixture was rolled on a laboratory roll mill at 185° C. for 5 min. The rolled sheets were investigated by the “hot fogging test” at 60° C.

### Hot Fogging Test, 60° C.:

| | Clouding | Formation | |
|---|---|---|---|
| | on the film | of drops | Clear film |
| Sample | after s | after s | after s |
| E2 | immediate | 60 | 300 |
| E3 | immediate | 45 | 210 |

E2 is prior art and E3 is according to the invention.

### Examples 4 to 9

| Example: | E4 | E5 | E6 | E7 | E8 | E9 |
|---|---|---|---|---|---|---|
| PVC EVIPOL SH 7020 | 100 | 100 | 100 | 100 | 100 | 100 |
| DOA PLASTOMOL | 7 | 7 | 7 | 7 | 7 | 7 |
| EDENOL D 81 | 15 | 15 | 15 | 15 | 15 | 15 |
| EDENOL 1215 | 15 | 15 | 15 | 15 | 15 | 15 |
| STABIOL VCZ 2222 | 0.8 | 0.8 | 0.8 | 0.8 | 0.8 | 0.8 |
| LOXIOL G 71S | 0.2 | 0.2 | 0.2 | 0.2 | 0.2 | 0.2 |
| LOXIOL G 10 V | 1.5 | — | — | 1.6 | — | — |
| DISPONIL SMO 120 | 1.5 | — | 1.2 | — | — | — |
| SPEZ. | | | | | | |
| DISPONIL SML 20 | — | — | — | 0.8 | — | 0.8 |
| Product of Example 1 | — | 3.0 | 1.2 | — | 2.4 | 1.6 |

The components of Examples E4-E6 were mixed together and the mixture was rolled on a laboratory roll mill from Berstorff Maschinenfabrik at 185° C. for min. The rolled sheets were investigated by the “cold fogging test” at 25° C./8° C.

### Cold Fogging Test, 25° C. Water Temperature/8° C. Ambient Temperature

| | Clouding | Formation | |
|---|---|---|---|
| | on the film | of drops | Clear film |
| Sample | after s | after s | after s |
| E4 | immediate | >600 | — |
| E5 | immediate | 60 | 360 |
| E6 | immediate | <<60 | 60 |

E4 is prior art and E5 and E6 are according to the invention.

The components of Examples E7-E9 were mixed together and the mixture was rolled on a laboratory roll mill from Berstorff Maschinenfabrik at 185° C. for 5 min. The rolled sheets were investigated by the “hot fogging test” at 60° C.

### Hot Fogging Test, 60° C.:

| | Clouding | |
|---|---|---|
| | on the film | Clear film |
| Sample | after s | after s |
| E7 | immediate | >300 |
| E8 | immediate | >360 |
| E9 | immediate | 60 |

E9 is according to the invention.

### Raw Materials:

| Trade name | Manufacturer | Constituent/function |
|---|---|---|
| PVC EVIPOL | Ineos GmbH | PVC |
| SH 7020 | | |
| DOA PLASTOMOL | BASF ES | plasticizer |
| EDENOL D 81 | Cognis Oleochemicals | epoxidized soya oil |
| | GmbH | |
| STABIOL VCZ 2222 | Reagens GmbH | Ca/Zn stabilizer |
| LOXIOL G 10 V | Cognis Oleochemicals | glycerol monooleate |
| | GmbH | |
| DISPONIL SMO 120 | Cognis GmbH | PEG sorbitan monooleate |
| SPEZ. | | |
| DISPONIL SML 20 | Cognis GmbH | PEG sorbitan |
| | | monolaurate |
| LOXIOL P 1508 | Cognis Oleochemicals | lubricant |
| | GmbH | |
| LOXIOL G 20 | Cognis Oleochemicals | lubricant |
| | GmbH | |
| Edenol 1215 | Cognis Oleochemicals | polymer plasticizer |
| | GmbH | |
| Loxiol G 71S | Cognis Oleochemicals | release agent |
| | GmbH | |

Note:
Cognis Oleochemicals GmbH has recently changed its name to Emery Oleochemicals GmbH.

1. An anti-fogging agent, comprising
a) an ester product obtainable by a process comprising as process steps:
S1) provision of a reaction mixture comprising as reaction components
S1a) a polyglycerol comprising at least two glycerol units;
S1b) an oil based on a natural oil;
S2) reaction of the reaction mixture by a transesterification in the presence of a basic catalyst to give the ester product;
b) at least one further anti-fogging agent chosen from the group consisting of a polyethylene glycol ether, a partial glyceride or a polyethylene glycol ester or a mixture of at least two of these.

2. The anti-fogging agent according to claim 1, wherein the transesterification is carried out as a one-pot process.

3. The anti-fogging agent according to claim 1 wherein the basic catalyst is chosen from the group consisting of alkali metal hydroxide, alkaline earth metal hydroxide or hydroxides of main group III or a mixture of at least two of these.

4. The anti-fogging agent according to claim 1 wherein the oil is chosen from the group consisting of rape oil, castor oil, hydrogenated castor oil, sunflower oil, palm oil, soya oil, tallow oil, hydrogenated tallow oil, coconut oil and groundnut oil or a mixture of at least two of these.

5. The anti-fogging agent according to claim 1 wherein the polyglycerol has an average number of from 1.5 to 5 glycerol units per molecule.

6. The anti-fogging agent according to claim 1 wherein the transesterification is carried out in the presence of at least one further alcohol.

7. The anti-fogging agent according to claim 6, wherein the further alcohol comprises at least two hydroxyl groups.

8. The anti-fogging agent according to claim 6 wherein the further alcohol is chosen from the group consisting of glycerol, sorbitol, pentaerythritol, trimethylolpropane or alkoxylates thereof, polyethylene glycol and polypropylene glycol.

9. The anti-fogging agent according to claim 1 wherein the process is carried out in a reaction mixture which contains the following reaction components:
at least about 10 wt. % of oil,
from about 5 to about 90 wt % of polyglycerol,
from about 0.0001 to about 1 wt % of basic catalyst,
from 0 to about 40 wt. % of a further alcohol with at least two hydroxyl groups,
from 0 to about 20 wt. % of additives which differ from the above reaction components,
in each case based on the reaction mixture, wherein the sum of the percentages of the reaction components is 100.

10. The anti-fogging agent according to claim 1 with at least one of the following properties:
P1 a viscosity in a range of from about 1.5 to about 15 mPas
P2 a density in a range of from about 0.8 to about 0.95 g/cm³.

11. A polymer composition comprising an ester product, an anti-fogging agent of claim 1 and at least one polymer.

12. The polymer composition according to claim 11, wherein the polymer is chosen from the group consisting of polyvinyl chloride, polypropylene, polyethylene, polyethylene/polypropylene copolymers, polyethylene terephthalate, polylactate, polycarbonate, polyesters and mixtures of these.

13. The polymer composition according to claim 11 comprising from about 0.05 to about 10 wt. % of the ester product.

14. The polymer composition according to claim 11, which comprises the following components:
at least about 10 wt. % of a polymer,
from about 0.05 to about 20 wt % of the ester product,
from 0 to about 10 wt % of further anti-fogging agent,
from 0 to about 75 wt % of additives.

15. The polymer composition according to claim 11, wherein the composition is a thermoplastic polymer composition.

16. A process for the production of a shaped article, wherein a polymer composition according to claim 11 is processed to give the shaped article.

17. A shaped article comprising a polymer composition according to claim 11.

18. The shaped article according to claim 17 in the form of a film, an outer facing, a transparent moulding, a window, a visor or spectacle lens.

19. A process for the production of a thermoplastic shaped article, comprising the process steps:
I) provision of the anti-fogging agent according to claim 1;
II) heating of the thermoplastic composition to the glass transition temperature of the thermoplastic polymer or to a temperature above the glass transition temperature of the thermoplastic polymer; and
III) production of a shaped article from the heated thermoplastic composition prepared in process step II).

20. The process according to claim 19, wherein in a further process step IV) at least a part region of the shaped article obtained in process step III) is reduced in its mass cross-section compared with process step III).

21. A process for the production of a packed product, comprising as process steps:
a) provision of a product and of a shaped article according to claim 17 or of a mixture of at least two of these as a pack shaped article;
b) at least partial surrounding of the product with the pack shaped article.
